(19) United States
(12) Patent Application Publication
(10) Pub. No.: US 2025/0079541 A1
(43) Pub. Date: Mar. 6, 2025

(54) TRACTION BATTERY FOR BATTERY-POWERED VEHICLE

(71) Applicant: MAHLE International GmbH, Stuttgart (DE)

(72) Inventors: Dieter Reisinger, Muehlacker (DE); Dragos-Cristian Iancu, Hitzhofen (DE); Thomas Klambach, Ostfildern (DE); Eduard Reimer, Fellbach (DE)

(21) Appl. No.: 18/822,060

(22) Filed: Aug. 30, 2024

(30) Foreign Application Priority Data
Sep. 1, 2023 (DE) 10 2023 208 443.0

(51) Int. Cl. H01M 10/48; B60L 50/64; H01M 50/213; H01M 50/249; H01M 50/258; H01M 50/284; H01M 50/298

(52) U.S. Cl. CPC H01M 10/486; B60L 50/64; H01M 10/482; H01M 50/213; H01M 50/249; H01M 50/258; H01M 50/284; H01M 50/298; H01M 2220/20

(57) ABSTRACT

A traction battery for a battery-powered vehicle is disclosed. The traction battery includes at least one battery module that has a plurality of rechargeable electrochemical battery cells. The battery module has a battery housing which has a housing interior for accommodating the battery cells and a flat housing base on which the plurality of battery cells are directly or indirectly supported. At least one temperature sensor arranged on the battery housing for measuring a temperature of the battery cells. The at least one temperature sensor is arranged in the housing interior on the inside of the housing in such a way that a respective battery cell is supported on the housing base via the at least one temperature sensor with an end face of the battery cell facing the housing base.

### CROSS-REFERENCE TO RELATED APPLICATION

This application claims priority to German Application No. DE 10 2023 208 443.0 filed on Sep. 1, 2023, the contents of which are hereby incorporated by reference in its entirety.

### TECHNICAL FIELD

The present invention relates to a traction battery for a battery-powered vehicle.

### BACKGROUND

A generic traction battery is known, for example, from DE 10 2020 135 014 A1 and comprises at least one battery module that has several rechargeable electrochemical battery cells. The battery module has a battery housing with a housing interior for accommodating the battery cells and a flat housing base on which the battery cells are directly or indirectly supported. Furthermore, the battery module has a temperature sensor arranged on the battery housing for measuring the temperature of the battery cells. The battery cells are designed as cylindrical round cells such that they each have a longitudinal center axis and two end faces facing away from each other with respect to the longitudinal center axis of the cell. The battery cells are arranged in the housing interior in such a way that their longitudinal center axes run parallel to each other and perpendicular to the housing base, such that the battery cells are each supported directly or indirectly on the housing base via one of the end faces. In the known traction battery, the temperature sensor is arranged on the outside of the housing, preferably in a sensor recess formed for this purpose on the outside of the battery housing, in particular on the outside of a housing cover opposite the housing base. With the familiar traction battery, the temperature of the outside of the housing is therefore measured in order to draw conclusions about the temperature of the battery cells. In the case of traction batteries with temperature control of the battery cells, which causes the battery cells to be cooled or heated as required, the temperature measured on the outside of the battery housing deviates greatly from the actual temperature of the battery cells.

Knowing the current temperature of the battery cells as accurately as possible is an advantage for safe operation of the traction battery. In particular, this allows imminent overheating of the battery cells to be detected at an early stage so that appropriate countermeasures can be initiated in good time.

The present invention deals with the problem of providing an improved embodiment for a traction battery of the type described above, which is characterized in particular by an improved measurement of the temperature of the battery cells.

According to the invention, this problem is solved by the subject-matter of the independent claim(s). Advantageous embodiments are the subject of the dependent claims.

### SUMMARY

The invention is based on the general idea of arranging at least one temperature sensor in the housing interior on the inside of the housing. In this way, the temperature is measured directly inside the housing so that the measured temperature corresponds relatively accurately to the actual temperature of the battery cells. Furthermore, according to the invention, it is proposed to arrange the respective temperature sensor in the housing interior in such a way that one of the battery cells is supported on the housing base with its end face facing the housing base via the temperature sensor. This results in a plurality of advantages. On the one hand, the temperature of the battery cells is measured directly on one of the battery cells on behalf of all other battery cells, so that the actual temperature of the battery cells is determined almost immediately with the aid of the temperature sensor. This also applies in particular if the traction battery is equipped with a temperature control system for heating or cooling the battery cells as required. Furthermore, the temperature sensor integrated into the support of the battery cell at the housing base can be easily arranged, fixed, or positioned in the battery housing. In the case of an immersion-tempered traction battery, in which a dielectric and in particular liquid temperature control medium flows through the battery housing so that the battery cells come into direct contact with the temperature control medium, the temperature sensor arranged between the end face of the respective battery cell and the housing base does not form an obstacle to the temperature control medium flowing around the respective battery cell. This also improves the efficiency of temperature control in the region of the battery cell whose temperature is measured using the temperature sensor.

Preferably, the traction battery can be configured as an immersion-tempered traction battery so that a temperature control path is routed through the battery housing in such a way that a temperature control medium routed from the temperature control path comes into direct contact with the battery cells. Depending on the operating state of the traction battery, it may be necessary to cool or heat the battery cells in order to optimize the performance of the traction battery. A temperature-controlled, in particular immersion-tempered, traction battery is configured for tempering of the battery cells such that the battery cells can be cooled or heated as required.

In the present context, the term “configuration” is synonymous with the term “arrangement” so that the phrase “configured in such a way that” is synonymous with the phrase “arranged in such a way that”.

The flat housing base defines a plane in which the housing base essentially extends. The phrase “perpendicular to the housing base” refers to the plane of the housing base in which the flat housing base extends.

According to an advantageous embodiment, the temperature sensor can be clamped between the housing base and the respective battery cell perpendicular to the housing base. This clamping ensures that the temperature sensor is positioned securely enough and held in place on the housing base and on the respective battery cell.

The temperature sensor can usefully have a sensor body, via which the respective battery cell is supported on the housing base, and at least one sensor element for temperature measurement. As a result, the various functions of the temperature sensor are fulfilled by corresponding components, which can be optimized in this respect. The support function is fulfilled by the sensor body, while the temperature measurement function is fulfilled by the respective sensor element. This makes it possible to manufacture the temperature sensor cost-effectively.

The sensor body can usefully have a cell support body in contact with the respective battery cell and a base support body in contact with the housing base. By using two separate bodies for support on the housing base on the one hand and on the front of the respective battery cell on the other, different materials and/or different material properties can be realized on the two bodies in particular in order to optimize the support and/or the temperature measurement. The respective sensor element can be conveniently arranged on or in the base support body, whereby it is located close to the battery cell to be measured, but is decoupled from the support on the respective battery cell.

A preferred embodiment is one in which the sensor body also has a carrier body which has an upper body side facing the respective battery cell and an underside of the body facing the housing base. The cell support body is fastened to the upper body side, while the base support body is fastened to the underside of the body. The respective fastening can be an adhesive connection, for example. If a plastic is used for the cell support body and/or for the base support body, the respective body can also be molded or foamed onto the carrier body. The base support body has an element recess for the respective sensor element, in which the respective sensor element is arranged and within which the respective sensor element is fastened to the carrier body. This means that the respective sensor body is largely arranged within the base support body. The respective element recess can be designed as a through-opening that completely penetrates the base support body perpendicular to the housing base. Alternatively, the respective element recess can be designed as a blind hole so that it is closed on the side facing away from the carrier body. The respective sensor element is then encapsulated by the base support body and the carrier body. In the case of temperature control, the respective sensor element is then protected from contact with the temperature control medium.

It may be useful for the carrier body to be formed by a section of a flexible printed circuit board. A flexible printed circuit board usually has a dielectric single-layer or multi-layer film and can also be referred to as an FPCB, wherein FPCB stands for Flexible Printed Circuit Board. There are electrical conductor tracks on or in the film. The flexible printed circuit board can, for example, be designed as a flexible printed circuit or FPC, wherein FPC stands for Flexible Printed Circuit, or as a flat foil cable or FFC, wherein FFC stands for Flexible Flat Cable. The film with the conductor tracks can be bent elastically, making the printed circuit board flexible. Such flexible printed circuit boards are particularly inexpensive to produce and can be configured with a very thin wall thickness and therefore extremely flat. This means that the temperature sensor only requires a small amount of installation space perpendicular to the housing base.

Another preferred embodiment is one in which the base support body is designed as an elastic foam body, while the cell support body is designed as a rigid or stiff or dimensionally stable solid body. The design of the base support body and the cell support body is thus such that when the respective battery cell is normally or properly pressed against the housing base via the temperature sensor parallel to the longitudinal center axis of the cell, the elastic base support body is elastically deformed or compressed by at least 10%, while the dimensionally stable cell support body is not deformed or compressed by less than 1%. This makes it easier to clamp the temperature sensor between the housing base and the respective battery cell. At the same time, manufacturing tolerances can also be compensated for. Another important advantage of this configuration is that by designing the cell support body as a rigid or stiff solid, the respective sensor element, which is attached to the side of the carrier body facing away from the battery cell, always has the same relative position with respect to the battery cell to be measured, regardless of the compression of the base support body designed as an elastic foam body, so that the desired temperature can be measured largely independently of manufacturing tolerances of the battery cells and the battery housing.

Conveniently, the base support body or the cell support body can be dielectrically configured or consist of a dielectric material. Likewise, both the base support body and the cell support body can be dielectrically configured or made of corresponding dielectric materials. Additionally or alternatively, it may be provided that the cell support body is designed as an FR4 body, so that it is formed by a dielectric rigid or stiff or dimensionally stable solid body. Additionally or alternatively, the base support body can be made of polyurethane foam and accordingly be formed from a dielectric elastic foam body.

According to another advantageous embodiment, the respective sensor element can be configured as a surface-mounted element. In particular, the respective sensor element can then be attached to the carrier body particularly easily and in a space-saving manner. Such surface-mounted elements are also referred to as SMD, wherein SMD stands for Surface Mounted Device. Additionally or alternatively, the respective sensor element can be configured as a thermistor element. Such thermistor elements are also known as NTC elements, wherein NTC stands for Negative Temperature Coefficient. The electrical resistance of a thermistor decreases with increasing temperature.

According to an advantageous embodiment, the respective temperature sensor can have a signal line that is led out of the battery housing. Signals from the temperature sensor or the respective sensor element that correlate with the measured temperature can be transmitted via the signal line to a corresponding evaluation unit, in particular to a battery monitoring circuit. This type of conductor-based signal transmission is extremely reliable.

Advantageously, the housing base can have an opening through which the signal line is led out of the battery housing. In particular, this means that the signal line can be routed out of the battery housing relatively close to the battery cell whose temperature is measured using the temperature sensor. Accordingly, the signal line takes up very little installation space inside the housing.

The signal line can usefully be designed as a flat conductor. A flat conductor of this type requires extremely little installation space, so that more volume is available inside the housing for the temperature control medium, for example, if temperature control is provided. Optionally, the passage opening can also be designed as a slot. As a result, the passage opening is adapted to the contour of the signal line, which is designed as a flat conductor, making it easier, for example, to securely seal the housing interior against the surroundings of the battery housing in the region of the passage opening.

The signal line connects the respective temperature sensor to a battery monitoring circuit or CSC, wherein CSC stands for Cell Supervision Circuit. For this purpose, the signal line can have an electrical interface to the CSC at an end remote from the respective temperature sensor, which can be realized with classic connection technologies between the conductors, such as FPC, FFC, cable, the signal line, and a CSC board or PCB, wherein PCB stands for Printed Circuit Board. For example, connectors, direct soldering, or laser welding can be used here.

The respective signal line can be routed directly to the dry outdoor region where the CSC is located, which processes the signals from the respective temperature sensor. In the case of an immersion-tempered traction battery, the respective signal line can also run inside the battery modules. If the traction battery is configured as an immersion-tempered traction battery, a temperature control medium channel can run along the outside of the housing on the housing base, in which the temperature control medium flows during operation of the traction battery. The passage opening can now be positioned in such a way that it is open towards the temperature control medium channel, i.e., it fluidically connects the housing interior with the temperature control medium channel. An opening cross-section of the passage opening can be adapted to the outer cross-section of the signal line in such a way that leakage through the passage opening can be easily reduced or controlled. A gap remains between the passage opening and the signal line, which can be so small that it creates a throttling effect that acts as a gap seal without the need for a separate sealing element. Any remaining leakage is then so small that it can be tolerated. Alternatively, a separate sealing element can also be used to seal the signal line in the passage opening against the battery housing.

The signal line can be configured longitudinally and have a first longitudinal section running along the inside of the housing and a second longitudinal section running along the outside of the housing. While the first longitudinal section leads to the respective sensor element, the second longitudinal section can lead to the respective evaluation unit mentioned above.

In another advantageous embodiment, it may be provided that the signal line is configured as a flexible printed circuit board, in particular as an FPCB or as an FPC or as an FFC. A flexible printed circuit board of this type has a very thin wall thickness and therefore requires little installation space.

A configuration in which the carrier body of the temperature sensor is formed by a section of the flexible printed circuit board that forms the signal line is particularly advantageous. This results in an extremely simple design for the temperature sensor with signal line.

According to an advantageous embodiment, the housing base can have at least one protrusion protruding into the housing interior on the inside of the housing, on which the respective temperature sensor is supported perpendicular to the housing base. This protrusion improves the contact between the temperature sensor and the housing base on the one hand and the respective battery cell on the other.

The sensor body can have a round and preferably circular cross-section perpendicular to the housing base. Accordingly, the protrusion of the housing base can also have a round, in particular circular, cross-section perpendicular to the housing base.

The base support body can also be fixed to the battery cell with an adhesive as an option. Suitable adhesive systems are very thin, in particular less than 50 μm, and can, for example, be based on acrylates with or without a carrier film. The effect on the measurement is negligible here. The use of an adhesive system can significantly improve the robustness of the measuring point, e.g., in the event of mechanical stress caused by vibration and shock.

The battery housing conveniently also has a housing wall which runs around the battery cells in a closed manner and which, in particular, can be formed at least partially integrally on the housing base. In addition, the battery housing can have a housing cover, which in particular is also configured to be flat and is arranged on a side of the battery housing facing away from the housing base. The housing wall can also be at least partially integral with the housing cover. Furthermore, the respective battery module can have at least one cell holder, which is arranged in the housing interior and which positions a plurality of battery cells relative to each other and relative to the battery housing. This enables a reliable flow around all battery cells, particularly in the case of immersion temperature control.

Other important features and advantages of the invention can be seen from the dependent claims, from the drawings, and from the associated description of the figure based on the drawings.

It is understood that the above-mentioned features and those yet to be explained below can be used not only in the combination indicated in each case, but also in other combinations or on their own, without deviating from the scope of the invention defined by the claims. The components of a superordinate unit, such as a device, an apparatus, or an arrangement, which are described separately, having been mentioned above or to be mentioned below, can represent separate components of this unit or can form integral areas or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

They show, schematically in each case,

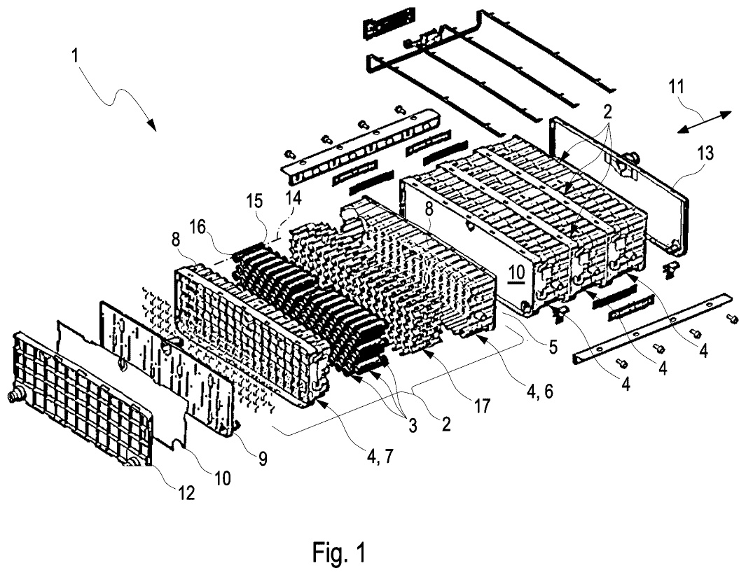

FIG. 1 is an isometric view of a traction battery with a plurality of battery modules stacked together and a dismantled battery module in an isometric exploded view,

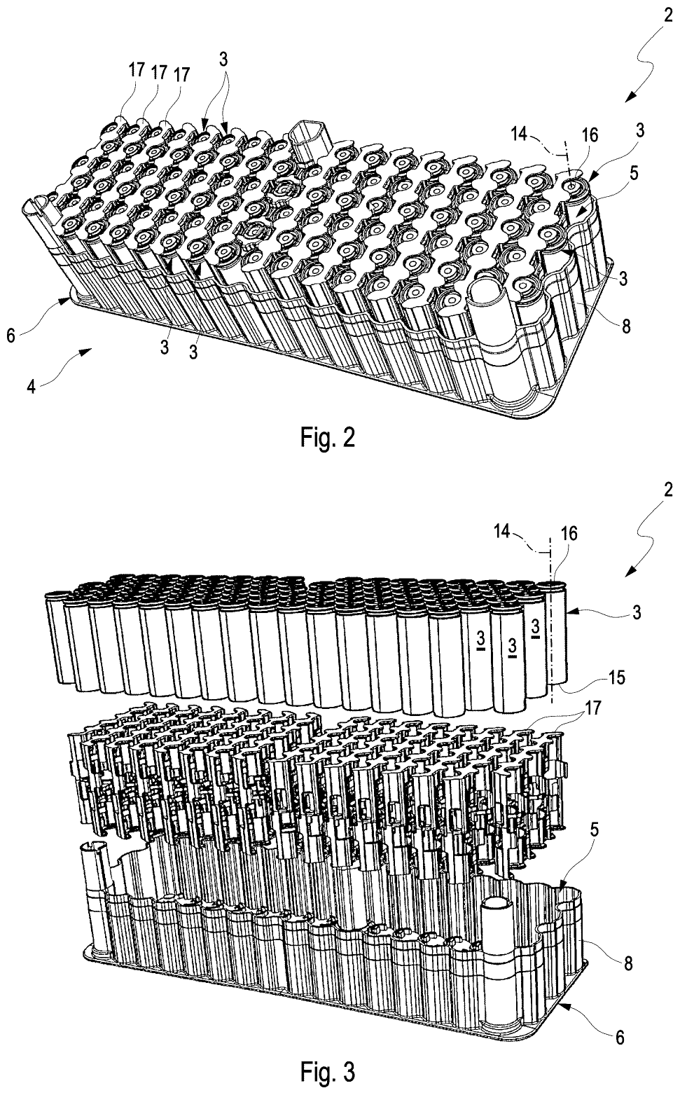

FIG. 2 is an isometric view of a battery module that is only partially shown,

FIG. 3 is an exploded view of part of the battery module,

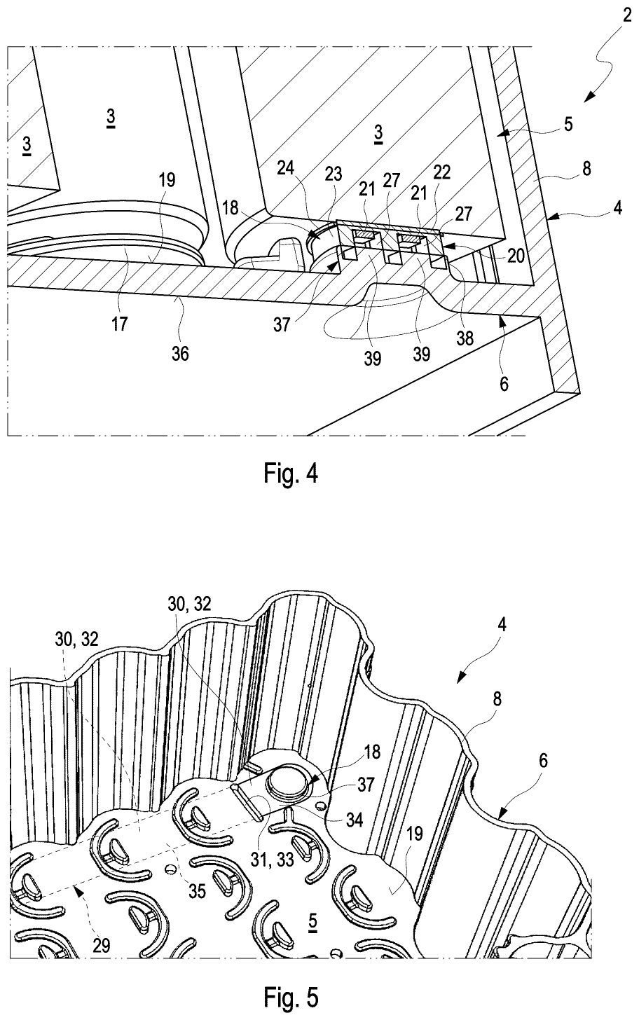

FIG. 4 is an isometric sectional view of the battery module in the region of a temperature sensor,

FIG. 5 is an isometric view of the inside of a housing in the region of the temperature sensor,

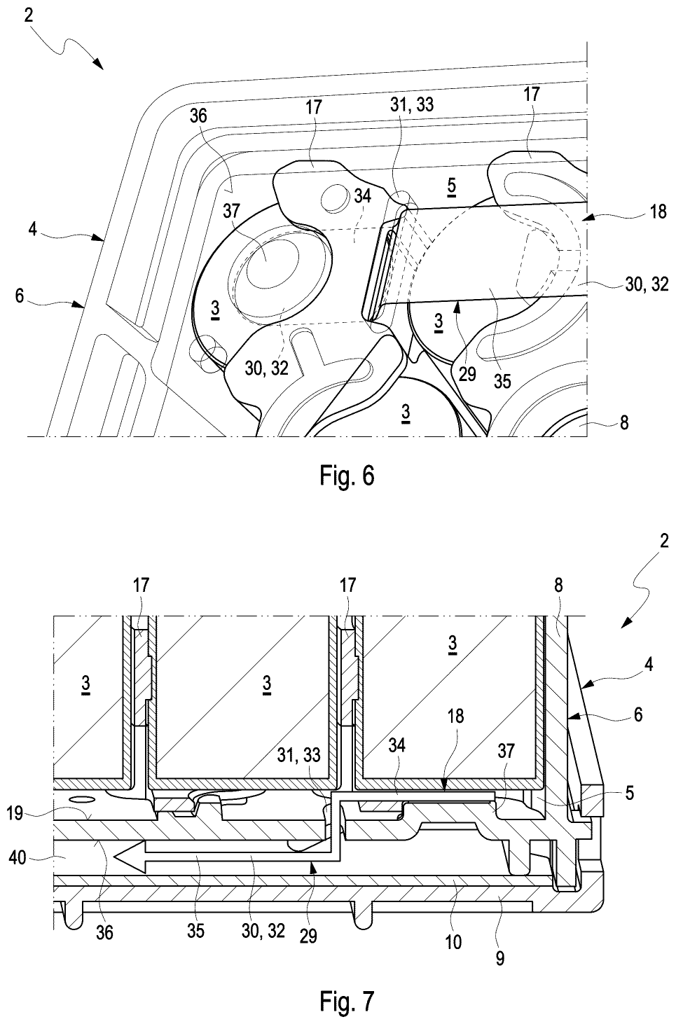

FIG. 6 is an isometric view of the outside of the housing in the region of the temperature sensor,

FIG. 7 is a sectional view of the battery module in the region of the temperature sensor,

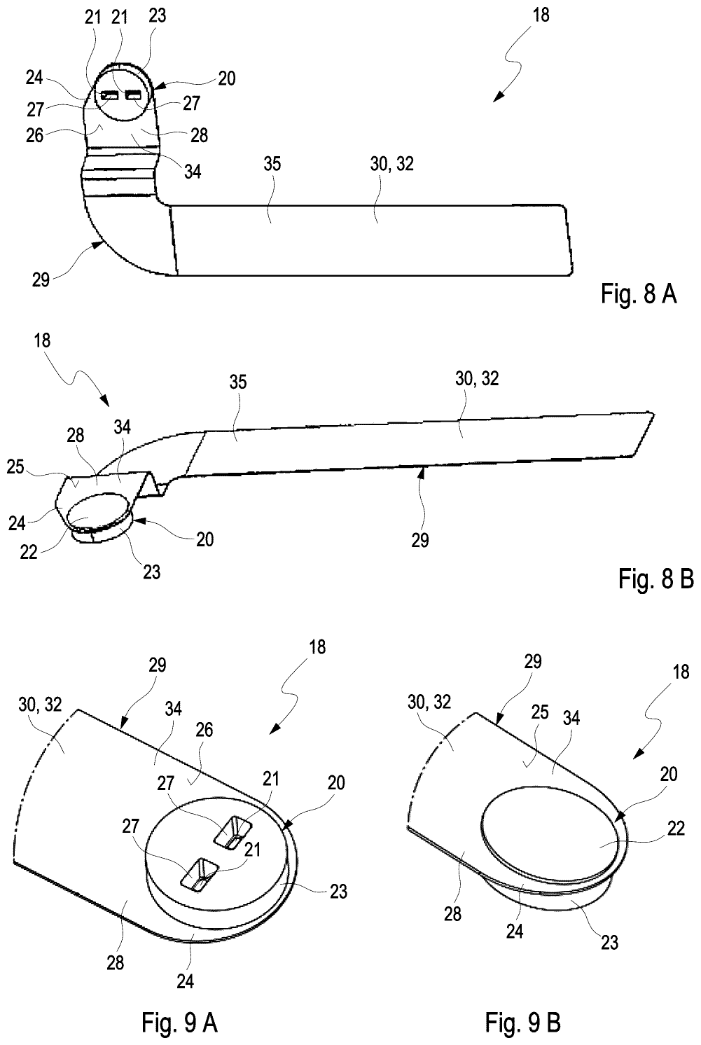

FIG. 8A is an isometric view from above of the temperature sensor,

FIG. 8B is an isometric view of the temperature sensor from below,

FIG. 9A is an enlarged isometric view from above of the temperature sensor in the region of a sensor body,

FIG. 9B is an enlarged isometric view from below of the temperature sensor in the region of the sensor body.

### DETAILED DESCRIPTION

According to FIG. 1, a traction battery 1 configured for a battery-powered vehicle comprises at least one battery module 2 having a plurality of rechargeable electrochemical battery cells 3. FIG. 1 shows a traction battery 1 with four such battery modules 2, wherein the three battery modules 2 shown on the right are shown in an assembled state and are built together or stacked together, while the fourth battery module 2 shown on the left is shown pulled apart so that the individual components are recognizable. The respective battery module 2 has a battery housing 4, which has a housing interior 5 for accommodating the battery cells 3 and a flat housing base 6. The battery cells 3 are supported directly or indirectly on the housing base 6. The respective battery housing 4 also has a housing cover 7, which is also designed to be flat and lies perpendicular to the housing base 6 opposite the housing base 6. In addition, the battery housing 4 has a housing wall 8, which in the example shown here is integrally formed partly on the housing base 6 and partly on the housing cover 7. The housing wall 8 runs around the housing interior 5 and thus around the battery cells 3 housed in it. A fluid distributor plate 9 and an intermediate plate 10 can be arranged between adjacent battery modules 4. The battery modules 4 are stacked with respect to a stacking direction 11. With regard to the stacking direction 11, there is a front end plate 12, and a rear end plate 13 at the longitudinal ends of the traction battery 1. Conveniently, the traction battery 1 is configured as an immersion-tempered traction battery 1, such that a corresponding dielectric tempering medium, in particular a dielectric fluid, can be supplied and discharged via corresponding connections, which are recognizable, for example, on the rear end plate 13. The fluid distributor plates 9 support a targeted flow through the housing interiors 5 of the battery modules 4 of the traction battery 1, wherein the battery cells 3 come into direct contact with the temperature control medium.

FIG. 1 shows further peripheral components of the traction battery 1, which are not described in detail and can be used, for example, for electrical contacting, fluid distribution, and for fastening the battery modules 2 to each other. The individual battery modules 2 or their battery housings 4 can be appropriately configured in a cuboid shape.

The battery cells 3 are configured here as cylindrical, in particular circular-cylindrical, round cells, each of which has a longitudinal center axis 14 and two end faces 15 and 16 that face away from each other with respect to the longitudinal center axis 14 of the cell. Furthermore, the battery cells 3 are arranged in the housing interior 5 in such a way that their longitudinal center axes 14 run parallel to each other and perpendicular to the flat housing base 6. The battery cells 3 are each supported directly or indirectly on the housing base 6 via one of the end faces 15, 16, in this case via the one or first end face 15. Electrical contact is then usually made with the battery cells 3 on the other or second end face 16, although this is not shown in detail. To improve the predetermined positioning of the battery cells 3 within the housing interior 5, a plurality of cell holders 17 can be used, each of which interacts with a plurality of battery cells 3 to position and hold them in the battery housing 4. For example, FIG. 2 shows that a plurality of such cell holders 17 are provided for this purpose, each of which is arranged between two regions of adjacent battery cells 3 in order to position them relative to one another. FIGS. 4, 6, and 7 also show that the battery cells 3 are supported on the housing base 6 via sections of the cell holders 17.

It is noteworthy that the stacking direction 11, in which the battery modules 2 are attached to each other, runs parallel to the longitudinal center axes 14 of the battery cells 3. When installed, the traction battery 1 is mounted on the vehicle in such a way that the stacking direction 11 extends essentially horizontally, resulting in a horizontal arrangement for the battery cells 3 in the operational traction battery 1 or in the vehicle.

At least one of the battery modules 2 is equipped with at least one temperature sensor 18, which is configured to measure a temperature of the battery cells 3. Conveniently, each battery module 2 has at least one such temperature sensor 18. The temperature sensor 18 is shown in FIGS. 4 through 9.

As shown in FIGS. 4 through 9, the temperature sensor 18 is arranged in the housing interior 5 on an inside of the housing 19 in such a way that one of the battery cells 3 is supported on the housing base 6 by its end face 15 facing the housing base 6 via this temperature sensor 18. Preferably, the temperature sensor 18 can be clamped between the housing base 6 and the respective battery cell 3 perpendicular to the housing base 6.

As shown in FIGS. 4, 8, and 9, the temperature sensor 18 has a sensor body 20 and at least one sensor element 21. In the embodiment shown here, the temperature sensor 18 has two sensor elements 21 that are connected redundantly or enable redundant temperature measurement. The respective battery cell 3 is supported on the housing base 6 via the sensor body 20. The sensor body 20 has a cell support body 22 in contact with the respective battery cell 3 and a base support body 23 in contact with the housing base 6. The respective sensor element 21 is arranged on or in the base support body 23. Furthermore, the sensor body 20 can have a carrier body 24, which has an upper body side 25 facing the respective battery cell 3, which is fastened to the cell support body 23, and an underside of the body 26 facing the housing base 6, which is fastened to the base support body 23. The respective sensor element 21 is preferably fastened to the underside of the body 26 on the carrier body 24. For this purpose, an element recess 27 can be formed in the base support body 23 for the respective sensor element 21, in which the respective sensor element 21 is arranged. The respective element recess 27 is configured here as a through-opening that completely penetrates the base support body 23.

The carrier body 24 can be formed by a section 28 of a flexible printed circuit board 29. The base support body 23 can be designed as an elastic foam body and be made of polyurethane foam, for example. In contrast, the cell support body 22 can be designed as a rigid or stiff or dimensionally stable solid body and can, for example, be designed as an FR4 body. Both the base support body 23 and the cell support body 22 are suitably dielectrically configured or consist of dielectric materials. The respective sensor element 21 is preferably a surface-mounted element that is fastened directly to the underside of the body 26 on the carrier body 24, preferably soldered on. Preferably, the respective sensor element 21 is configured as a thermistor element. The base support body 23 can be glued or foamed to the carrier body 24. The cell support body 22 can be glued or molded to the carrier body 24.

As shown in FIGS. 5 through 9, the temperature sensor 18 has a signal line 13 that is routed out of the battery housing 4. For this purpose, the housing base 6 can be equipped with a passage opening 31 through which the signal line 30 is led out of the battery housing 4. In the example shown here, the signal line 30 is designed as a flat conductor 32, which is characterized by a flat cross-section. Complementary to this, the passage opening 31 is configured here as a slot 33. Accordingly, the signal line 30 has a first longitudinal section 34 running along the inside of the housing 19 and a second longitudinal section 35 running along the outside of the housing 36. In FIG. 6, the outside of the housing 36 of the housing base 6 faces the viewer, wherein the housing base 6 is shown transparent to allow a view into the housing interior 5. The first longitudinal section 34 concealed by the housing base 6 is shown in FIG. 6 with a broken line, while the second longitudinal section 35 visible on the outside of the housing 36 is shown with a solid line. In contrast, in FIG. 5 the inside of the housing 19 in the region of the housing base 6 faces the viewer, so that the first longitudinal section 34 running there is shown with a solid line, while the second longitudinal section 35, which is concealed by the housing base 6 and runs along the outside of the housing 36, is shown with a broken line.

A configuration in which the signal line 30 is configured as a flexible printed circuit board 29 is preferred. This makes it particularly easy to configure the signal line 30 as a flat conductor 32. The signal line 30, designed as a flexible printed circuit board 29, now extends into the sensor body 20 in a particularly practical manner. A configuration in which the carrier body 24 of the sensor body 20 is formed by a section 28 of the flexible printed circuit board 29, which forms the signal line 30, is particularly advantageous. The signal line 30 is also not shown in full in FIGS. 8A and 8B. In particular, the signal line 30 may have an interface to a battery monitoring circuit or CSC at its end remote from the respective temperature sensor 18, which is not shown.

If the traction battery 1 is configured as an immersion-tempered traction battery 1, a temperature control medium channel, according to FIG. 7, can run along the outside of the housing 36 on the housing base 6, in which the temperature control medium 40 flows during operation of the traction battery 1. The through-opening 31 can now be appropriately positioned so that it is open towards the temperature control medium channel 40 and thus fluidically connects the housing interior 5 with the temperature control medium channel 40. The signal line 30, which penetrates the passage opening 31, blocks the free cross-section of the passage opening 31 to such an extent that no leakage or only a small leakage occurs, which is tolerable. The first longitudinal section 34 of the signal line 30 therefore runs in the housing interior 5, while the second longitudinal section 35 runs in the temperature control medium channel 40.

According to FIGS. 4 through 7, the housing base 6 can have a protrusion 37 on the inside of the housing 19 for the respective temperature sensor 18, which protrudes into the housing interior 5 and is positioned in such a way that the temperature sensor 18 is supported on this protrusion 37 perpendicular to the housing base 6.

In the examples of FIGS. 5 through 7, the protrusion 37 on the inside of the housing 19 has a flat and continuous surface on which the sensor body 20 is supported. In contrast, FIG. 4 shows a particular embodiment in which the surface of the protrusion 37 facing the housing interior 5 is shaped to complement the base support body 23. In particular, the protrusion 37 can have a circumferential collar 38, the free inner cross-section of which essentially corresponds to the outer cross-section of the base support body 23, so that the base support body 23 can be inserted axially into the collar 38 with respect to the longitudinal center axis 14 of the respective battery cell 3. Additionally or alternatively, the protrusion 37 for the respective element recess 27 may have a complementary elevation 39 which penetrates axially into the associated element recess 27 with respect to the longitudinal center axis 14 of the respective battery cell 3. FIG. 4 shows a state during assembly in which the respective elevation 39 has not yet penetrated axially into the associated element recess 27 and the base support body 23 has not yet penetrated axially into the collar 38.

As can be seen in particular from FIGS. 5 and 6, the temperature sensor 18 can preferably be assigned to such a battery cell 3, which is located in a corner region of the overall cuboid battery housing 4. This simplifies the routing of the signal line 30.

1. A traction battery for a battery-powered vehicle, comprising:
at least one battery module that has a plurality of rechargeable electrochemical battery cells,
the at least one battery module has a battery housing which has a housing interior for accommodating the plurality of battery cells and a flat housing base on which the plurality of battery cells are directly or indirectly supported,
the at least one battery module has at least one temperature sensor arranged on the battery housing for measuring a temperature of the plurality of battery cells,
the plurality of battery cells are cylindrical round cells, each of which has a longitudinal center axis and two end faces facing away from each other with respect to the longitudinal center axis of the cell,
the plurality of battery cells are arranged in the housing interior in such a way that their cell longitudinal center axes run parallel to each other and perpendicular to the housing base, so that the plurality of battery cells are each supported directly or indirectly on the housing base via one of the end faces,
the at least one temperature sensors arranged in the housing interior on the inside of the housing in such a way that a respective battery cell of the plurality of battery cells is supported on the housing base via the at least one temperature sensor with its end face facing the housing base.

2. The traction battery according to claim 1, wherein the at least one temperature sensor is clamped between the housing base and the respective battery cell perpendicular to the housing base.

3. The traction battery according to claim 1, wherein the at least one temperature sensor has a sensor body, via which the respective battery cell is supported on the housing base, and at least one sensor element for temperature measurement.

4. The traction battery according to claim 3, wherein:
the sensor body has a cell support body resting against the respective battery cell and a base support body resting against the housing base,
the at least one sensor element is arranged on or in the base support body.

5. The traction battery according to claim 4, wherein:
the sensor body has a carrier body which has an upper body side fastened to the cell support body and an underside of the body fastened to the base support body,
the at least one sensor element is arranged in an element recess formed on the base support body and is fastened to the underside of the body on the carrier body.

6. The traction battery according to claim 5, wherein the carrier body is formed by a section of a flexible printed circuit board.

7. The traction battery according to claim 4, wherein:
the base support body is an elastic foam body,
the cell support body is a rigid solid.

8. The traction battery according to claim 4, wherein at least one of:
the base support body and/or the cell support body is dielectrically configured or consists of a dielectric material,
the cell support body is an FR4 body,
the cell support body is bonded to the battery cell via an acrylate adhesive system, and
the base support body is made of polyurethane foam.

9. The traction battery according to claim 4, wherein:
the at least one sensor element is configured as a surface-mounted element, and/or
the at least one sensor element is configured as a thermistor element.

10. The traction battery according to claim 1, wherein the at least one temperature sensor has a signal line which is led out of the battery housing.

11. The traction battery according to claim 10, wherein the housing base has a passage opening through which the signal line is led out of the battery housing.

12. The traction battery according to claim 11, wherein:
the signal line is a flat conductor, and
the passage opening is a slot.

13. The traction battery according to claim 10, wherein the signal line has a first longitudinal section running along the inside of the housing and a second longitudinal section running along the outside of the housing.

14. The traction battery according to claim 10, wherein the signal line is configured as a flexible printed circuit board.

15. The traction battery according to claim 5, wherein the at least one temperature sensor has a signal line, and the carrier body is formed by a section of flexible printed circuit board which forms the signal line.

16. The traction battery according to claim 1, wherein the housing base has at least one protrusion on the inside of the housing which protrudes into the housing interior and on which the at least one temperature sensors supported perpendicular to the housing base.

17. A battery-powered vehicle, comprising: a traction battery, the traction battery including:
at least one battery module that has a plurality of rechargeable electrochemical battery cells,
the at least one battery module has a battery housing which has a housing interior for accommodating the plurality of battery cells and a flat housing base on which the plurality of battery cells are directly or indirectly supported,
the at least one battery module has at least one temperature sensor arranged on the battery housing for measuring a temperature of the plurality of battery cells,
the plurality of battery cells are cylindrical round cells, each of which has a longitudinal center axis and two end faces facing away from each other with respect to the longitudinal center axis of the cell,
the plurality of battery cells are arranged in the housing interior in such a way that their cell longitudinal center axes run parallel to each other and perpendicular to the housing base, so that the plurality of battery cells are each supported directly or indirectly on the housing base via one of the end faces,
the at least one temperature sensor is arranged in the housing interior on the inside of the housing in such a way that a respective battery cell of the plurality of battery cells is supported on the housing base via the at least one temperature sensor with its end face facing the housing base.

18. The battery-powered vehicle according to claim 17, wherein the at least one temperature sensor is clamped between the housing base and the respective battery cell perpendicular to the housing base.

19. The battery-powered vehicle according to claim 17, wherein the at least one temperature sensor has a sensor body, via which the respective battery cell is supported on the housing base, and at least one sensor element for temperature measurement.

20. The battery-powered vehicle according to claim 19, wherein:
the sensor body has a cell support body resting against the respective battery cell and a base support body resting against the housing base, and
the at least one sensor element is arranged on or in the base support body.
